(19) United States
(12) Patent Application Publication
(10) Pub. No.: US 2005/0228511 A1
(43) Pub. Date: Oct. 13, 2005

(54) Computer-implemented system and method for measuring and improving manufacturing processes and maximizing product research and development speed and efficiency

(76) Inventors: Suvajit Das, Atlanta, GA (US); Thierry Cresson, Roswell, GA (US); Jerzy W. Skowronski, Florence, SC (US); Randy A. Hempel, Ellicott City, MD (US); Steve Yang, Reisterstown, MD (US); Brian H. Rutledge, Eldersburg, MD (US); Ebi Elaahi, New City, NY (US); Bryan Miller, Ashburn, VA (US)

Correspondence Address: CONNOLLY BOVE LODGE & HUTZ, LLP, P O BOX 2207, WILMINGTON, DE, 19899, US

(21) Appl. No.: 10/501,561

(22) PCT Filed: Jan. 15, 2003
(86) PCT No.: PCT/US03/01272

§ 371 Date: Jul. 14, 2004

Related U.S. Application Data
(60) Provisional application No. 60/348,871, filed on Jan. 15, 2002.

(51) Int. Cl. G05B 13/02; G06F 19/00

(52) U.S. Cl. 700/28; 700/47; 700/96; 700/108

(57) ABSTRACT

An integrated multi-step computer-implemented system and method for measuring and improving manufacturing processes and maximizing product research and development speed and efficiency is disclosed. The system includes a predictive model that predicts output from data input, an optimizer that optimizes input variables based upon desired output variables, and a library that stores data and information. The system further includes an artificial intelligence that receives requests and information from manufacturers and customers, and directs the requests and information to the predictive model if an output prediction is requested, to the optimizer if an optimized input is requested, or to the library if the requests cannot be answered by the predictive model or optimizer. The predictive model, the optimizer, and the library all interconnect with the artificial intelligence. The system further includes a high-throughput screening system that analyzes various material combinations and sends data to the library.

### CROSS-REFERENCE TO RELATED APPLICATIONS AND CLAIM FOR PRIORITY

The present application is a U.S. National Stage application filed under 35 U.S.C. § 371, claiming priority of International application No. PCT/US03/01272, filed Jan. 15, 2003, and U.S. Provisional Patent Application Ser. No. 60/348,871, filed Jan. 15, 2002, under 35 U.S.C. §§ 119 and 365, the disclosures of the above-referenced applications being incorporated by reference herein in their entireties.

### BACKGROUND OF THE INVENTION

A. Field of the Invention

The present invention relates generally to process optimization and prediction techniques, and, more particularly to an integrated, multi-step computer-implemented system and method for measuring and improving manufacturing processes and maximizing product research and development speed and efficiency using high-throughput screening and governing semi-empirical modeling.

B. Description of the Related Art

The globally-linked network of computers known as the Internet presents many opportunities today. The world-wide web (WWW), which is one of the facilities provided on top of the Internet, comprises many pages or files of information, distributed across many different server computer systems. Information stored on such pages can be presented to the user's computer system (“client computer system”) using a combination of text, graphics, audio data and video data. Each page is identified by a Universal Resource Locator (URL). The URL denotes both the server machine, and the particular file or page on that machine. There may be many pages or URLs resident on a single server.

Many manufacturing processes are equipped with a variety of sensors and instrumentation that physically attach to the process and provide signals which can be interpreted by electronic, pneumatic, or mechanical systems to provide manufacturing operators with real-time information about various operating parameters. As used herein the term “online measurement” shall refer to this type of monitoring.

In paper manufacturing, for example, online measurement may include a fixed or traversing opacity or brightness sensor that delivers a signal to a control system operated either in manual or automatic mode to monitor, record, and control the opacity and brightness of the surface being tested.

In many processes, online measurement and control systems alone fail to control the process sufficiently to manufacture a product of “good” quality according to comparison with a set of defined characteristics. Thus, offline measurement may be required. For example, in paper manufacturing quantitative color measurements are most often achieved by collecting a sample of the in-process or finished product at the process point for which the property is desired. Collection of such samples is a destructive process that requires an interruption in the manufacturing process. In this instance, online measurement is not considered sufficiently accurate for comparison to quantitative numerical color specifications and visual standards. The sample is transported, with some time delay, to a test site that may be located adjacent or remote to the manufacturing sampling site. The results are recorded, and the information may or may not be relayed to and/or received by the manufacturing operator immediately.

As used herein the term “offline measurement” shall refer to this type of monitoring. Thus, offline measurement may include collecting physical samples from the process for observation and testing. Such samples are physically removed from the process at discrete time intervals and certain locations. Properties of the samples are subsequently tested in offline chemical or physical laboratories or testing sites. Date is recorded and sometimes stored in electronic format.

An additional form of process monitoring is process observation by manufacturing operators. As used herein, the term “process observation” shall refer to the uninstrumented observations of the process. Uninstrumented observations involve use of the human senses such as sight, sound, smell, etc. to measure process parameters which are not currently measurable using existing technology. These observations may be recorded in data logs which may then be electronically recorded.

The manufacturing process may be controlled using a combination of online measurement, offline measurement, and process observation. Frequently, for example, online measurement is used to compare current machine sensor outputs to desired set points and automatically adjust a control input (e.g., a control valve) so that the sensor output reaches the target. Such control techniques will be referred to herein as “automated control”. For many complex manufacturing processes, the manufacturing operators cannot rely solely on automated control to produce a product that meets standards that define it to be both “in specification” and “fit for use”. Many times online measurement sensors are not used as inputs to automated control loops. Offline measurement and process observations are infrequently used for automated control. The manufacturing operator synthesizes a combination of automated control, online measurements, offline measurements, and process observations to control the process and make products that are both in specification and fit for use.

Manufacturing operators have different sense, prioritization, evaluation, and response capability. They also have various levels of experience, training, and process understanding that result in a variety of degrees of skill in controlling the manufacturing process or processes in their domain. The scientific and engineering “first-principles” based on physics and chemistry are often either not known or not well understood by the operator. As a result, sub-optimal process control results. Even in the case where first-principles models exist, they are not incorporated into the manufacturing and product development process. Consequently, manufacturing has incomplete real-time process information and lack of first principle models in place which can be incorporated into a supervisory control system that makes control optimal.

In summary, many conventional manufacturing processes lack sufficient real-time information about critical performance parameters. Manufacturing operators have some real-time process information, but first principle models are not in place. In many conventional systems, data is located on site, preventing effective mathematical and statistical manipulation to develop first principle models and supervisory control systems. As a result, operators and automatic control systems guess at the true status of the process based upon experience or models. Improved process visibility through new or enhanced sensors is needed in many cases.

Inadequate process understanding is a hindrance to effective control in many manufacturing processes. Building sound, first-principles dynamic process models that are adaptable and can be extended over the full range of operating conditions is a key to improving the effectiveness of control systems and operators. All of the available data from sensors, pumps, control valves, other plant devices, etc. are not being used as effectively as possible.

Current process control systems present data to operators largely through computer displays or panels with gauges and alarm lights. The data typically indicate the status of individual process variables and associated control status. Relationships among multiple process variables and long-term dynamic responses are not presented to the operators. Supervisors, engineers, and maintenance employees get diagnostic information from control systems largely upon demand.

Existing process control systems have significant limitations since they do not use advanced control methods such as predictive model control. Advanced predictive models that combine empirical models with first principles do not currently exist. Consequently, good control performance requires continual loop tuning to keep the system effective as minor changes occur in manufacturing conditions. Current self-tuning approaches are inadequate for manufacturing processes. Automated diagnostics currently used are relatively simple and information to operators about control system performance is weak.

Frequent changes in the product being manufactured, and inconsistency of the source and quality of raw material and feedstock are commonplace in many industries. Yet control of transitions in major process areas is accomplished typically by operators rather than by automatic control systems. Many process areas are controlled with little information about the upstream and downstream processes. As a result, changes in feedstock, production rate, product type, etc. ripple up and down the manufacturing chain, causing process upsets and products that do not meet specifications, and economic sub-optimization. Thus there is a need in the art for a dynamic, predictive control system that coordinates control of multiple processes.

Many manufacturing processes are also not adequately understood in terms of interactions among operating parameters and cause/effect relationships. The fundamental scientific principles need to be recognized and understood in order for a robust dynamic model of a process to be developed and used effectively. Existing static models are not sufficiently useful to control dynamic processes, especially complex processes that are not well understood. If dynamic models existed, they could be used to estimate product properties and unmeasured process parameters. Thus, there is a need for a first-principle, dynamic process model that can be used in making decisions both by operators and supervisors, and by automatic control systems.

First-principle models of some individual unit processes have been proposed which promise enough sophistication to allow their use in developing dynamic models. Empirical models are not first principle models. Unlike first-principle models, empirical models are based on mathematical correlations of certain parameters within the range of data collected. Therefore, they cannot be readily extrapolated to new conditions. Consequently, empirical models are limited in their usefulness. In contrast, first-principle models are based on data generated in controlled laboratory conditions.

Many manufacturers use standard procedures for a particular manufacturing system. Since there can be variations in input materials and processing parameters, the standard manufacturing procedures may lead to poorly-made products. Such goods may then have to be reprocessed or thrown out, which leads to a loss in time and resources. It is therefore the desire of many manufacturers to get the desired product in the first process.

The thrust of manufacturing in the decades to come will be toward continuing reductions in cost, improvements in quality, and most dramatically for the change in manufacturing methods, a vastly increased flexibility of manufacture to respond immediately to market trends. Such flexibility has been the hallmark of the success of many companies, for example, and is now being advocated for all types of business including those in the traditional hard goods sector.

The provision of manufacturing systems however that can deliver agile performance while maintaining the lowest cost and highest quality is extremely difficult. In years past, these three goals have been viewed as mutually exclusive. For example, in order to reduce cost, the famous Ford assembly line eliminated flexibility to market change, creating one style and producing it for a long period of time, with at least reasonable quality. Recently the Japanese, for example in the car business, have begun to hone the traditional processes of car manufacture to a fine degree raising the level of quality well beyond its previous state, but still with very little flexibility. Other cars, such as certain exotic marquees made in much smaller quantities, achieve quality and flexibility, but at high cost. Even with these however, flexibility is still not achieved until such extremely small volumes are reached that the car becomes virtually hand made.

There are other trends in the manufacturing technology world today, including intelligent sensors, machine intelligence, and knowledge-based systems. These form the building blocks on which the flexible machines and automation that can achieve the goals above in an accurate low cost manner can be built. Such building blocks have recently become possible economically due to the drastically lowering cost of the computation facilities, and the maturing of key sensor technologies, particularly electro-optics/machine vision, which allow them to be used reliably in manufacturing plants.

There is also a move toward openness in the controls areas, which allows the sensory data to be inputted in a manner suitable for action on the plant floor, but without being locked up by proprietary systems. The trend toward lower computer costs and memory costs has created a massive increase in the ability to use “knowledge and intelligence” to deal with the ever present problems on the plant floor. The trend toward knowledge and intelligence is manifested in the ever-increasing role of software, and the operation of reliable software in these machines is critical. Also critical is that the sensory data provided, which yields the basis on which intelligence can be done, is correct.

Manufacturers also have difficulty developing new products since it is expensive and time consuming to translate laboratory work to manufacturing conditions. The laboratory experiments are often scaled up using intermediate processes such as pilot equipment and must be verified on the manufacturing scale with production trials. A significant reason for the difficulty in scaling the process from the laboratory to production is that the laboratory experiments are conducted using a limited number of closely-controlled variables. Real production processes are influenced by more process variables and more variation of those process variables. Laboratory experiments are completed in static, steady state conditions. Production work is completed in dynamic, non-steady state conditions. Laboratory experiments assume all significant process inputs are controlled or held constant. In a dynamic manufacturing environment, there may be significant process inputs which are unknown, unmeasured, or not well understood. Therefore, the process inputs that are significant in a manufacturing environment is different and more complex that the laboratory environment. This makes process scale-up difficult.

A typical product scale-up process proceeds as follows. Laboratory experiments under controlled conditions are used to determine the basic process variable settings. The role of the manufacturing operator is to find a way to duplicate the laboratory effects at different conditions in order to achieve satisfactory results. The manufacturing operator cannot duplicate the laboratory effects using the same conditions because of differences between the laboratory and manufacturing scale, equipment, measurement points, and number and variability of process inputs. The laboratory has little or no knowledge about the specific actions taken by the manufacturing operator to control the process. Similarly, the manufacturing operator has experience with a specific process making existing products, but has no knowledge of how to create the new product with new chemistry and process settings. To determine the specific process chemistry and process settings to make the new product, the laboratory and manufacturing staff run a “trial” by which process inputs are evaluated on a trial-and-error basis. This iterative process repeats until a set of manufacturing conditions are identified that produce the desired effect in the new product. However, there is no way to know whether or not the process settings are the most efficient or economical possible. This iterative process may take months or years to accomplish, if a successful combination can be found at all. Since it is difficult to know whether or not the process is operating at optimal conditions, the trial ends when performance is reached at reasonable cost.

Thus, there is a need in the art to provide a means for measuring and optimizing manufacturing processes, and for simultaneously minimizing manufacturing process costs, and maximizing product research and development speed and efficiency.

### SUMMARY OF THE INVENTION

The present invention satisfies the needs of the related art by providing a computer-implemented system and method for measuring and improving manufacturing processes and maximizing product research and development spending, through utilization of advanced technologies and modeling. The present invention also connects advanced scientific measurement models with computer-aided combinatorial chemistry, high-throughput testing, site-specific databases and process data, optimization and predictive algorithms, and scientists to deliver a state of the art solutions platform and knowledge delivery system and method. Each service offering is built around a real-time Internet backbone with individualized databases built by developing a large database of general chemical interactions and will connect that to individual process feeds.

The present invention provides a radical departure from the conventional product development process. The basic chemical and process data are determined through a high-throughput screening process. A combinatorial evaluation of several process settings is thus completed. The machine settings necessary for the manufacturing process are determined through use of first principle models combined with statistical evaluation of operating variables. The laboratory and manufacturing process are seamlessly combined into a semi-empirical model to provide the most effective and efficient means to produce the new product on the specific manufacturing process. Iteration, uncertainty, and the time and expense for scale-up are minimized. Rather than first running iterative machine production trials to evaluate the product made with the new settings, the system and method of the present invention will run virtual trials using an online Internet-based semi-empirical model and online real-time process data that as been collected, stored, and analyzed in a web-based database. Virtual production trials can be completed in seconds or minutes rather than days or weeks. The results of the virtual trials are then used to fine-tune the process settings so that the new product can be made in a manufacturing process or industry with new process settings with a minimum of iteration and sub-optimal production. The production scale-up may be completed within a shortened scale-up cycle. First, a developmental production run verifies the predicted settings and product results. The data collected during this developmental run will be transferred to the on-line database via the Internet, evaluated using the semi-empirical model, and optimized in a virtual manner to provide the optimal settings for a second final confirming production run.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate one embodiment of the invention and together with the description, serve to explain the principles of the invention. In the drawings:

FIG. 1 is a schematic diagram showing a system of an embodiment of the present invention;

FIG. 2 is a schematic diagram showing a client, server, or client/server of the system of FIG. 1;

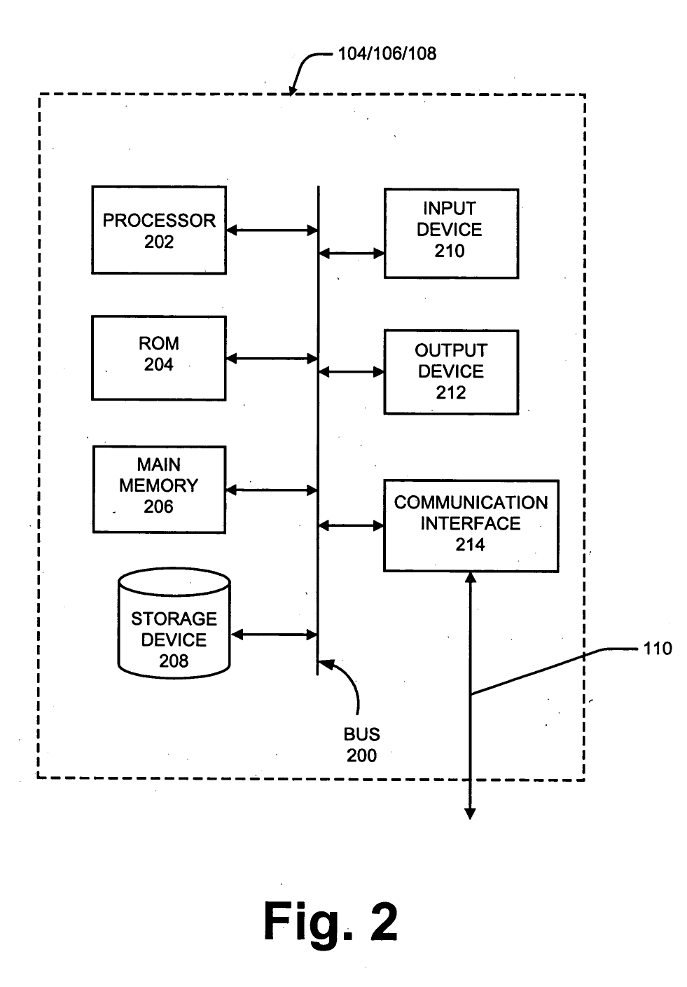

FIG. 3 is a schematic diagram showing the primary components of the system shown in FIG. 1; and

FIG. 4 is a schematic diagram showing further components of the system shown in FIG. 1.

### DETAILED DESCRIPTION OF THE PRESENT INVENTION

Reference will now be made in detail to the present invention, an example of which is illustrated in the accompanying drawings. Wherever possible, the same reference numbers will be used throughout the drawings to refer to the same or like parts.

The present invention is broadly drawn to an integrated, multi-step computer-implemented system and method for measuring and improving manufacturing processes and maximizing product research and development speed and efficiency using high-throughput screening and governing semi-empirical modeling. The present invention is a knowledge-based service system and method that provides solutions to various industries. Examples of such industries include, but are not limited to, paint, plastics, paper, coatings, semiconductor, glass, steel, chemical, metal, etc.

The present invention enables such industries to utilize advanced technologies and modeling abilities to measure and improve their process operations, and maximize their product innovation spending. The present invention also connects advanced scientific measurement models with computer-aided combinatorial chemistry, high-throughput testing, site-specific databases, and scientists to deliver a state of the art solutions platform and knowledge delivery system. Each service offering is built around a real-time Internet backbone with individualized databases built by developing proprietary formulations for each manufacturer.

The present invention is unique in its ability to capture and leverage knowledge through a variety of channels. These knowledge channels in turn supply each targeted industry with service offerings that cover three specific areas: cost sensitive industries, process optimization, and future innovations.

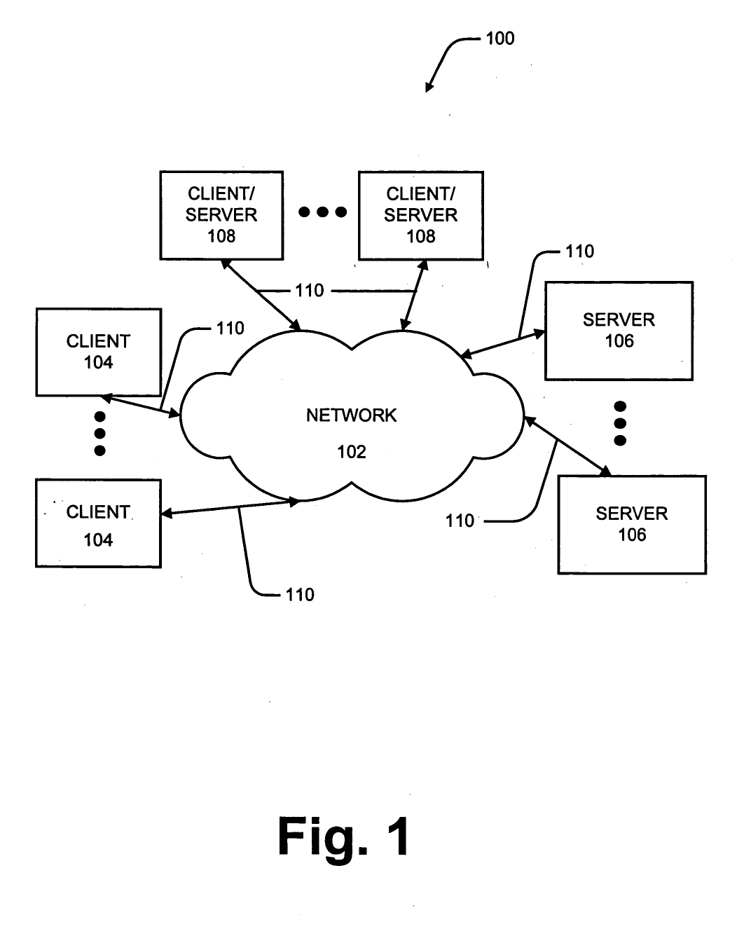

In accordance with the invention and as shown in FIG. 1, the system 100 of the present invention includes a network 102 that interconnects client entities 104, server entities 106 and client/server entities 108 via communication links 110.

Network 102 may comprise an Internet, intranet, extranet, local area network (LAN), wide area network (WAN), metropolitan area network (MAN), telephone network such as the public switched telephone network (PSTN), or a similar network.

The Internet is a collection of interconnected (public and/or private) networks that are linked together by a set of standard protocols (such as TCP/IP and HTTP) to form a global, distributed network. While this term is intended to refer to what is now commonly known as the Internet, it is also intended to encompass variations which may be made in the future, including changes and additions to existing protocols.

An intranet is a private network that is contained within an enterprise. It may consist of many interlinked local area networks and also use leased lines in the wide area network. Typically, an intranet includes connections through one or more gateway computers to the outside Internet. The main purpose of an intranet is to share company information and computing resources among employees. An intranet can also be used to facilitate working in groups and for teleconferences. An intranet uses TCP/IP, HTTP, and other Internet protocols and in general looks like a private version of the Internet. With tunneling, companies can send private messages through the public network, using the public network with special encryption/decryption and other security safeguards to connect one part of their intranet to another. Typically, larger enterprises allow users within their intranet to access the public Internet through firewall servers that have the ability to screen messages in both directions so that company security is maintained. When part of an intranet is made accessible to customers, partners, suppliers, or others outside the company, that part becomes part of an extranet.

An extranet is a private network that uses the Internet protocols and the public telecommunication system to securely share part of a business's information or operations with suppliers, vendors, partners, customers, or other businesses. An extranet can be viewed as part of a company's intranet that is extended to users outside the company.

A LAN refers to a network where computing resources such as PCs, printers, minicomputers, and mainframes are linked by a common transmission medium such as coaxial cable. A LAN usually refers to a network in a single building or campus. A WAN is a public or private computer network serving a wide geographic area. A MAN is a data communication network covering the geographic area of a city, a MAN is generally larger than a LAN but smaller than a WAN.

PSTN refers to the world's collection of interconnected voice-oriented public telephone networks, both commercial and government-owned. It is the aggregation of circuit-switching telephone networks that has evolved from the days of Alexander Graham Bell. Today, PSTN is almost entirely digital in technology except for the final link from the central (local) telephone office to the user. In relation to the Internet, the PSTN actually furnishes much of the Internet's long-distance infrastructure.

An entity may include software, such as programs, threads, processes, information, databases, or objects; hardware, such as a computer, a laptop, a personal digital assistant (PDA), a wired or wireless telephone, or a similar wireless device; or a combination of both software and hardware. A client entity 104 is an entity that sends a request to a server entity and waits for a response. A server entity 106 is an entity that responds to the request from the client entity. A client/server entity 108 is an entity where the client and server entities reside in the same piece of hardware or software.

Connections 110 may be wired, wireless, optical or a similar connection mechanisms. “Wireless” refers to a communications, monitoring, or control system in which electromagnetic or acoustic waves carry a signal through atmospheric space rather than along a wire. In most wireless systems, radio-frequency (RF) or infrared (IR) waves are used. Some monitoring devices, such as intrusion alarms, employ acoustic waves at frequencies above the range of human hearing.

An entity, whether it be a client entity 104, a server entity 106, or a client/server entity 108, includes a bus 200 interconnecting a processor 202, a read-only memory (ROM) 204, a main memory 206, a storage device 208, an input device 210, an output device 212, and a communication interface 214. Bus 200 is a network topology or circuit arrangement in which all devices are attached to a line directly and all signals pass through each of the devices. Each device has a unique identity and can recognize those signals intended for it. Processor 202 includes the logic circuitry that responds to and processes the basic instructions that drive entity 104, 106, 108. ROM 204 includes a static memory that stores instructions and date used by processor 202.

Computer storage is the holding of data in an electromagnetic form for access by a computer processor. Main memory 206, which may be a RAM or another type of dynamic memory, makes up the primary storage of entity 104, 106, 108. Secondary storage of entity 104, 106, 108 may comprise storage device 208, such as hard disks, tapes, diskettes, Zip drives, RAID systems, holographic storage, optical storage, CD-ROMs, magnetic tapes, and other external devices and their corresponding drives.

Input device 210 may include a keyboard, mouse, pointing device, sound device (e.g. a microphone, etc.), biometric device, or any other device providing input to entity 104, 106, 108. Output device 212 may comprise a display, a printer, a sound device (e.g. a speaker, etc.), or other device providing output to entity 104, 106,108. Communication interface 214 may include network connections, modems, or other devices used for communications with other computer systems or devices.

As will be described below, an entity 104, 106, 108 consistent with the present invention may perform the method for measuring and improving manufacturing processes and maximizing product research and development spending (also known as the Optyxx system, Optyxx method, or Optyxx). Alternatively, multiple entities 104, 106, 108 may be interconnected together to perform the method of the present invention. Entity or entities 104, 106, 108 perform this task in response to processor 202 executing sequences of instructions contained in a computer-readable medium, such as main memory 206. A computer-readable medium may include one or more memory devices and/or carrier waves.

Execution of the sequences of instructions contained in main memory 206 causes processor 202 to perform processes that will be described later. Alternatively, hardwired circuitry may be used in place of or in combination with software instructions to implement processes consistent with the present invention. Thus, the present invention is not limited to any specific combination of hardware circuitry and software.

A. The Optyxx System

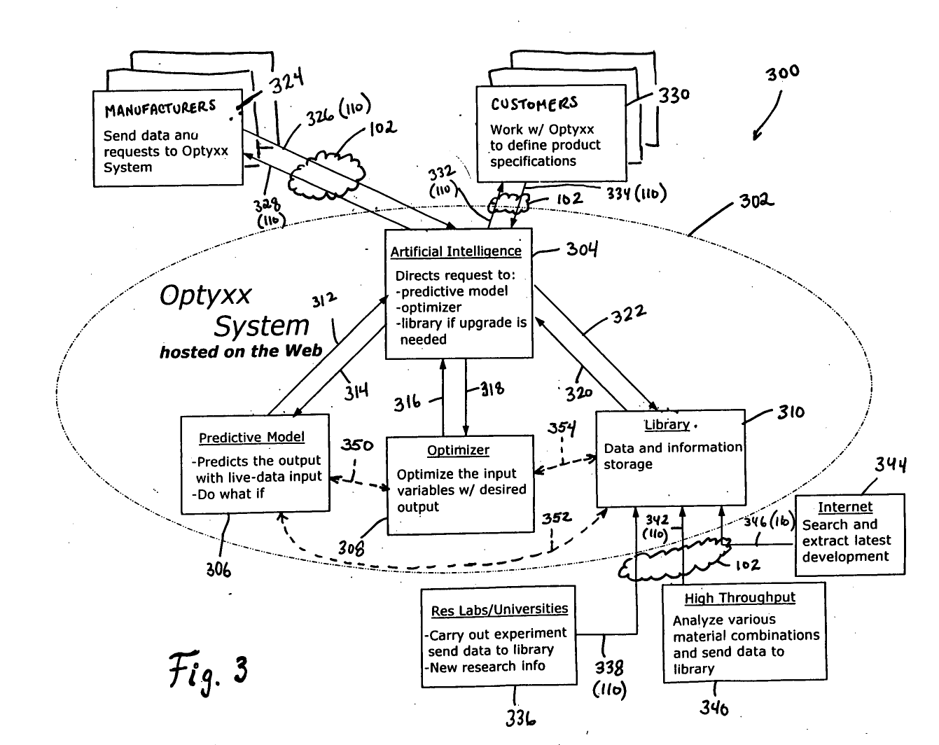

FIG. 3 provides a schematic diagram of the overall Optyxx system, in accordance with the present invention, and shown generally as reference numeral 300. The core of the Optyxx system is provided within the dashed lines, and is designated as reference numeral 302. The Optyxx system 302 includes an artificial intelligence 304 (also known as a system controller, as used herein, the terms “artificial intelligence” and “system controller” will be used interchangeably), a predictive model 306, an optimizer 308, and a library 310, each of which will be described more fully in the sections below. The Optyxx system 302 may be provided on a single entity 104, 106, or 108, or on any combination of multiple entities 104, 106, 108 that are interconnected together.

Artificial intelligence 304 interconnects with predictive model 306 so that communications may be received from 312 and sent to 314 predictive model 306. Artificial intelligence 304 also interconnects with optimizer 308 so that communications may be received from 316 and sent, via 318, to optimizer 308. Finally, artificial intelligence 304 interconnects with library 310 so that communications may be received from 320 and sent to 322 library. Predictive model 306, optimizer 308, and library 316 may also be interconnected via connections 350, 352, 354. All of the interconnections between artificial intelligence 304 and predictive model 306, optimizer 308, and library 310 may be via conventional means, such as for example, a bus 200 or conventional communications cables. Artificial intelligence 304, predictive model 306, optimizer 308, and library 310 may be stored in a conventional manner, such as for example, stored in a read-only memory (ROM) 204, a main memory 206, and/or a storage device 208.

The Optyxx system 302 connects via a network 102, preferably the Internet, to manufacturers 324. Each manufacturer 324 is capable of sending 326 and receiving 328, through connections 110, information to and from artificial intelligence 304 of the Optyxx system 302. For example, each manufacturer 324 may send live information from sensors monitoring its processes, request optimal process parameters to be calculated by Optyxx 302, may request a new process be formulated for a new product, etc.

The Optyxx system 302 also connects, via network 102, preferably the Internet, to customers 330 of the manufacturers. Each customer 330 is capable of sending 334 and receiving 332, through connections 110, information to and from artificial intelligence 304. For example, each customer 330 may send product specifications, a request for the cheapest manufacturer for a particular product, etc.

Alternatively, the Optyxx system 302 may operate without artificial intelligence 304, in which case connections 110 with manufacturers 324 and customers 330 would be directly with predictive model 306, optimizer 308, and/or library 310. In such an arrangement, the functions of artificial intelligence 304 may be built into predictive model 306 and/or optimizer 308.

Artificial intelligence 304 directs the requests or information from manufacturers 324 and customers 330 to predictive model 306, optimizer 308, and/or library 310, depending upon the request or information.

Library 310 may contain process information (e.g., sensor data) received from manufacturers 324, as well as, process parameters for specific products, product formulations, etc. Thus, the library 310 may contain databases holding information obtained from manufacturers 324 and customers 330 from various industries. Preferably, however, library 310 is supplemented with knowledge databases containing information and data from other sources.

For example, research laboratories and universities 336 may provide information and data received from new research in field(s) of the manufacturers 324. Research laboratories and universities 336 may also carry out experiments requested by manufacturers 324 or in response to a request by manufacturers 324 for new product or process formulations. Information from research laboratories and universities 336 may be provided, via a network 102 such as the Internet and a connection 338 (110), to databases contained within library 310.

Library 310 may further be supplied with information from a high-throughput screening system 340. For example, if manufacturers 324 or customers 330 desire a product having new properties, the high-throughput screening system 340 may analyze various material combinations and send data to database(s) of library 310. Information from high-throughput screening 340 may be provided, via a network such as the Internet and a connection 342 (110), to library 310.

Library 310 may also be supplied with information from searches and latest developments found from the Internet 344. In paper manufacturing, for example, the following information may be supplied to library 310: newly published properties characterizing raw materials such as fiber, fillers, pigments, dyes, etc.; current costing information; end use properties of final products; research describing newly discovered process parameters and their relationships with process outputs; raw data that can be further analyzed by the Optyxx system; etc.

Preferably, information provided by research laboratories and universities 336, and high-throughput testing 340 are provided via a network 102 such as the Internet. However, such information may be provided through direct communications cables, tapes, diskettes, Zip drives, RAID systems, holographic storage, optical storage, CD-ROMs, magnetic tapes, etc.

1. Artificial Intelligence or System Controller

Artificial intelligence (AI) systems (system controllers) can integrate data accumulation, data mining, recognition and storage functions with higher order analysis and decision protocols. AI systems such as expert systems and neural networks find wide application in qualitative analysis. Expert systems typically generate an individual data structure which is analyzed according to a knowledge base working in conjunction with a resident database, as shown, for example, in U.S. Pat. No. 5,253,164.

Neural network systems are networks of interconnected processing elements, each of which can have multiple input signals, but generates only one output signal. A neural network is trained by inputting training set of signals and correlating responses. The trained network is then used to analyze novel signals. For example, neural networks have been used extensively in optical character and speech recognition applications, as shown in U.S. Pat. No. 5,251,268.

Artificial intelligence 304 of the present invention may comprise conventional expert systems or neural networks set forth above, or a combination of the two. Preferably, artificial intelligence 304 will perform at least the following tasks. Artificial intelligence 304 will perform data mining, and categorization of incoming source information (in-process information, results of high-throughput screening, results of external testing laboratories, etc.), data type information; the proprietary nature of information, etc. Artificial intelligence 304 will also make decisions regarding the assignment of this information to the right and appropriate database location(s). Artificial intelligence 304 will determine search criteria based on the application needs, and coordinate the activity between the library 310, predictive model 306, and optimizer 308. Artificial intelligence 304 will perform search and retrieval of information from the database to the application, and recognize a lack of data or information as specified in the search criteria. In the event that information that matches the search criteria is found, artificial intelligence 304 will activate optimizer 308. Artificial intelligence 304 will request additional high throughput screening and/or laboratory testing at specific conditions based on the request of the optimizer 304. Artificial intelligence 304 will coordinate the search and retrieval of external sources such as the Internet for the search criteria, and coordinate incoming customer needs and specifications with database search routines, consulting assignments, off-line testing requirements, etc.

2. Predictive Model

Process models that are utilized for prediction, control and optimization can be divided into two general categories: (1) steady-state models and (2) dynamic models. In each case the model is a mathematical construct that characterizes the process, and process measurements are utilized to parameterize or fit the model so that it replicates the behavior of the process. The mathematical model can then be implemented in a simulator for prediction or inverted by an optimization algorithm for control or optimization.

Steady-state or static models are utilized in modern process control systems that usually store a great deal of data, this data typically containing steady-state information at many different operating conditions. The steady-state information is utilized to train a non-linear model. The steady-state model therefore represents the process measurements that are taken when the system is in a “static” mode. These measurements do not account for the perturbations that exist when changing from one steady-state condition to another steady-state condition. This is referred to as the dynamic part of a model.

A dynamic model is typically a linear model and is obtained from process measurements which are not steady-state measurements. Rather, these measurements are the data obtained when the process is moved from one steady-state condition to another steady-state condition. This procedure is where a process input or manipulated variable is input to a process with a process output or controlled variable being output and measured. Again, ordered pairs of measured data can be utilized to parameterize the empirical model, this time the data coming from a non-steady-state operation.

Plants have been modeled utilizing the various non-linear networks. One type of network that has been utilized in the past is a neural network. These neural networks typically comprise a plurality of inputs which are mapped through a stored representation of the plant to yield on the output thereof predicted outputs. These predicted outputs can be any output of the plant. The stored representation within the plant is typically determined through a training operation.

During the training of a neural network, the neural network is presented with a set of training data. This training data typically comprises historical data taken from a plant. This historical data is comprised of actual input data and actual output data, which output data is referred to as the target data. During training, the actual input data is presented to the network with the target data also presented to the network, and then the network trained to reduce the error between the predicted output from the network and the actual target data. One very widely utilized technique for training a neural network is a back-propagation training algorithm. However, there are other types of algorithms that can be utilized to set the “weights” in the network.

When a large amount of steady-state data is available to a network, the stored representation can be accurately modeled. However, some plants have a large amount of dynamic information associated therewith. This dynamic information reflects the fact that the inputs to the plant undergo a change which results in a corresponding change in the output. If a user desired to predict the final steady-state value of the plant, plant dynamics may not be important and this data could be ignored. However, there are situations wherein the dynamics of the plant are important during the prediction. It may be desirable to predict the path that an output will take from a beginning point to an end point. For example, if the input were to change in a step function from one value to another, a steady-state model that was accurately trained would predict the final steady-state value with some accuracy. However, the path between the starting point and the end point would not be predicted, as this would be subject to the dynamics of the plant. Further, in some control applications, it may be desirable to actually control the plant such that the plant dynamics were “constrained,” this requiring some knowledge of the dynamic operation of the plant.

In some applications, the actual historical data that is available as the training set has associated therewith a considerable amount of dynamic information. If the training data set had a large amount of steady-state information, an accurate model could easily be obtained for a steady-state model. However, if the historical data had a large amount of dynamic information associated therewith, i.e., the plant were not allowed to come to rest for a given data point, then there would be an error associated with the training operation that would be a result of this dynamic component in the training data. This is typically the case for small data sets. This dynamic component must therefore be dealt with for small training data sets when attempting to train a steady-state model.

Predictive model 306 of the present invention may comprise any conventional predictive model, including the above-mentioned techniques. Preferably, however, predictive model 306 will perform the following functions.

Predictive model 306 will perform multi-step modeling, including either all of a process system, or a part or parts of that process system. In paper manufacturing, for example, this may include modeling of an integrated or non-integrated paper mill with online and/or offline coating applications. The offline paper coating process will include the following units: coating preparation; size press operation; pre-calendaring; coating color application; paper coating interactions; coated paper drying; calendaring; finishing; printing. Predictive model 306 would model each process step independently based on first principles and empirical statistical relations. Then the interactions between each process step and the whole process are modeled as a whole. This defines the multi-step model.

As described above, an empirical model determines the relationship between all the inputs and the desired outputs at the same time. A first-principles model which deals only with one unit operation is based on controlled laboratory experimentation and scientific principles. Predictive model 306 is a semi-empirical model that combines the superior characteristics of both the first-principles and empirical models. The science and engineering principles of physics, chemistry, and mass-component-energy balances are common characteristic of both the first-principles model and the semi-empirical model. The use of real process inputs, conditions, and outputs are common characteristics of both the empirical model and the semi-empirical model. The semi-empirical model is unique in that it is consistent with both first-principles and the real response of a real manufacturing process.

The semi-empirical model will operate in a cascading multi-step manner, with each sub-process or unit operation having a number of critical input parameters and a different number of output parameters. Because the processes are interrelated, the output of one unit operation provides the input for the next unit operation(s).

The semi-empirical model will define equations, interactions, and logical relationships between inputs and outputs of each subprocess and the next subprocess. The semi-empirical model will provide results that will be sent, via artificial intelligence 304, to the appropriate place in library 310, to be used later on by optimizer 398.

Some manufacturing process steps have a low number of variables while other steps have a high number of variables. In paper manufacturing, for example, the operation units with low numbers of variables are refining, pressing, calendaring and sizing. The units with high numbers of variables are wet end chemistry, coating color preparation, coating color application and interactions and printing. In the present invention, preferably, the process steps with a high number of variables undergo high-throughput screening to define a lower number of critical variables.

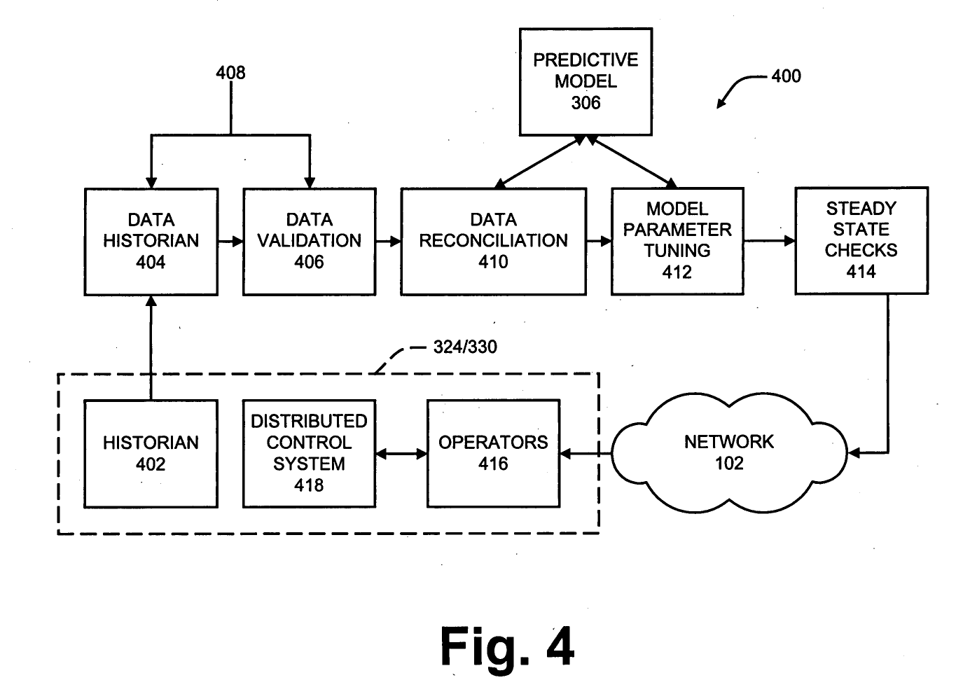

FIG. 4 shows further components of the Optyxx system 302 generally as reference numeral 400. As shown, historian data 402 from manufacturers 324 or customers 330 is provided to a data historian 404. This provides real time and historical exchange of plant process data like temperatures, flow rates, cost information, etc. Data historian 404 may comprise a data historian package available from OSI Software, Inc. of San Leandro, Calif. that stores and compresses plant process signals or manual input data (e.g., financial information). Data historian 404 may receive criteria 408 on which selected inputs are to be captured. Data historian 404 outputs data to data validation 406 where it is validated based upon embedded rules. Data validation 406 may be supplied by any commercial available software packages, such as, e.g., the validation software available from OSI Software, Inc. Data validation 406 screens good data from bad data per a set of rules. Good data is allowed to pass to data reconciliation 410, while bad data is either rejected or substituted per embedded rules. An alarm may be provided when bad data is rejected or substituted.

Data reconciliation 410 may be provided by commercially available software packages, such as, e.g., Automated Rigorous Performance Modeling (“ARPM”) software available from Invensys, Inc. ARPM uses real-time data and rigorous simulation models to extract validated process and equipment performance information. ARPM employs first-principles simulation techniques with proven data reconciliation technology to provide plant operating data that is consistent, comprehensive, timely, and trustworthy. Data reconciliation 410 assigns values for missing data and makes steady-state checks. The validated and reconciled data is then fed to predictive model 306. Data reconciliation 410 repeats every step predictive model 306 is run online, and ensures predictive model 306 is making accurate predictions. The frequency of this procedure may be established based upon the overall residence time of the process and is application specific.

Predictive model 306 may be provided by commercially available software packages, such as, e.g., the IDEAS process simulation package sold by AMEC Technologies, Inc. (“ATI”). Such simulation models may be configured and customized, manually or automatically, for each machine, plant, customer, manufacturer, etc. Predictive model 306 processes the data per algorithms that are embedded in the IDEAS simulation package. Plant conditions and/or finished or semi-finished product properties are predicted and output by predictive model 306.

The data may also be fed to a model parameter tuning block 412 that connects to predictive model 306 and fine tunes the outputs of predictive model 306. Model parameter tuning 412 provides data to a steady state check block 414 that is run when the data provided represents a steady-state condition. Model parameter tuning 412 and steady state check 414 may be performed by the IDEAS package or the ARPM package. Steady state check 412 may be made within data reconciliation 410 algorithm to assure the validity of the input data. Steady state check 412 also ensures that the results of predictive model 306 are reported to the customer 330 or manufacturer 324 after model 306 has fully converged and reached a steady-state condition. At that point, the results are passed, via network 102, to operators 416 and/or a distributed control system 418 of manufacturer 324 or customer 330.

3. Optimizer

When utilizing a model for the purpose of optimization, it is necessary to train a model on one set of input values to predict another set of input values at a future time. This will typically require a steady-state modeling technique. In optimization, especially when used in conjunction with a control system, the optimization process will take a desired set of set points and optimize those set points. However, since these models are typically selected for accurate gain, a problem arises whenever the actual plant changes due to external influences. Of course, one could regenerate the model with new parameters. However, the typical method is to actually measure the output of the plant, compare it with a predicted value to generate a “biased” value which sets forth the error in the plant as opposed to the model. This error is then utilized to bias the optimization network. To date, this technique has required the use of steady-state models which are generally offline models. The reason for this is that the actual values must “settle out” to reach a steady-state value before the actual bias can be determined. During operation of a plant, the outputs are dynamic.

Optimizer 308 of the present invention may comprise any conventional optimizer, including the above-mentioned techniques. Preferably, however, optimizer 308 will perform the following functions. Optimizer 308 requests artificial intelligence 304 to supply data from library 310 on certain performances in a certain requested range of performance, and the criteria by which the performance characteristics, process limitations, and basis for which the process will be evaluated (for example speed, cost, thermal efficiency, etc.). Optimizer 308 receives the equations from the library 310 and is able to identify a solution or solutions that satisfy the desired criteria within both the input, output, and processing specifications also received from the library 310. If artificial intelligence 304 determines that the optimization has succeeded within the limitations and equations defined, then the solution is transferred using artificial intelligence 304 to the appropriate place in library 310 for communication with the customer via the Internet. If optimizer 308 fails to find the solution within the zone for which data exists. Optimizer 308 will estimate the range outside the current data point range where the solution is expected. Extrapolation or interpolation is possible. Based on this estimate, optimizer 308 will request artificial intelligence 304 to coordinate the gathering of additional data to confirm the estimation. Artificial intelligence 304 will determine if the requested data is in library 310, or whether a new set of data must be delivered from a wider library search, or generated via an external web search, high-throughput screening, or additional laboratory work.

Optimizer 308 may be provided by commercially available software packages, such as, e.g., the Windows-based, multi-variant data analysis (“MVDA”) software package available from Umetrics of Umeå, Sweden and Kinnelon, N.J.

4. Library

Library 310 preferably includes multiple customer and industry specific databases, as well as knowledge database(s) consisting of information obtained from research laboratories and universities 336, high-throughput testing system 340, and Internet searches 344, as set forth above. Library 310 will also hold or store the industrial data during trial of a new product development, store data required to assist a paper machine operator in making an effective paper grade change. Library 310 will also host the laboratory and industrial data for data mining during a new product development.

5. High-Throughput Screening System

The discovery of new materials with novel chemical and physical properties often leads to the development of new and useful technologies. Currently, there is a tremendous amount of activity in the discovery and optimization of materials, such as superconductors, zeolites, magnetic materials, phosphors, catalysts, thermoelectric materials, high and low dielectric materials and the like. Unfortunately, even though the chemistry of extended solids has been extensively explored, few general principles have emerged that allow one to predict with certainty the composition, structure and reaction pathways for the synthesis of such solid state compounds.

The preparation of new materials with novel chemical and physical properties is at best happenstance with the current level of understanding. Consequently, the discovery of new materials depends largely on the ability to synthesize and analyze new compounds. Given the approximately 100 elements in the periodic table that can be used to make compositions consisting of two or more elements, an incredibly large number of possible new compounds remains largely unexplored. As such, there existed a need for a more efficient, economical and systematic approach for the synthesis of novel materials and for the screening of such materials for useful properties.

One of the processes whereby nature produces molecules having novel functions involves the generation of large collections (libraries) of molecules and the systematic high-throughput screening of those collections for molecules having a desired property. High-throughput screening of collections of chemically synthesized molecules and of natural products has played a central role in the search for lead compounds for the development of new pharmacological agents.

In International Patent Application No. WO 96/11878, the complete disclosure of which is incorporated herein by reference, methods and apparatus are disclosed for preparing a substrate with an array of diverse materials deposited in predefined regions. Some of the methods of deposition disclosed in WO 96/11878 include sputtering, ablation, evaporation, and liquid dispensing systems. Using the disclosed methodology, many classes of materials can be generated combinatorially including inorganics, intermetallics, metal alloys, and ceramics.

In general, combinatorial chemistry refers to the approach of creating vast numbers of compounds by reacting a set of starting chemicals in all possible combinations. Since its introduction into the pharmaceutical industry in the late 1980s, it has dramatically sped up the drug discovery process and is now becoming a standard practice in the industry. More recently, combinatorial techniques have been successfully applied to the synthesis of inorganic materials. By use of various surface deposition techniques, masking strategies, and processing conditions, it is now possible to generate hundreds to thousands of materials of distinct compositions per square inch.

High-throughput testing system 340 may comprise any conventional high-throughput screening (HTS) system, including the new advances stated above, to provide information and data to library 310 that may be used by manufacturers 324 and customers 330. HTS is a very effective substitution of inadequate offline measurement and subjective process observation. Offline measurement does not reflect reality because it is performed with some time delay and it takes more time to follow the testing procedure than the real process occurrence. HTS simulates the process and takes measurement in real time. Since HTS is an automated and statistically-designed multiple parallel testing, it can explore a high number of variables in a very short time to define the critical variables and their optimal range.

For example, in paper manufacturing, starting variables in HTS (unit input) for wet end chemistry include: fiber mass, fiber surface area, % of fines, fiber flexibility, TiO₂ grade, % TiO₂, Calcium Carbonate grade, % Clay grade, % white water conductivity, Coagulant, % Flocculants, % Polymer, % pH, % of broke, MD/CD ratio and vacuum. The outputs from wet end chemistry unit are: freeness, conductivity, flocculation, fines charge, fiber's zeta, drainage resistance, retention wet solids and press solids. Examples of starting variables (HTS inputs) for coating color preparation unit are: dewatering capability of base paper, TiO2 grade, %, Calcium Carbonate grade, %, Clay grade, %, dispersant, %, binder, co-binder, additive, dye, pH, solids. The outputs from this unit are: Zeta potential, flocculation, low shear viscosity, high shear viscosity, dissipated energy, dispersion stability, optical density and cost.

In a preferred embodiment, high-throughput testing system 340 may comprise a system that automates the chemical screening protocols, and runs twenty-four (24) experiments in the best optimized sequence to assess the effectiveness and impact of various chemical additive combinations. Such a system may include the following: (24) experimental cups or more with removable fine and coarse septa; (24) pH and temperature electrodes; (1) conductivity electrode in the first cup (the “Super cup”); (24) computer-controlled mixers with individual lifting mechanism; (10) chemical additives tanks and dispensing pumps; (1) filtrate tank equipped with conductivity and turbidity electrode to measure white water quality and pigment retention; (1) dual CPU industrial computer for multi-tasking, sequencing of the automated tasks and data acquisition; (1) industrial frame with brakes; (1) XYZ gantry to position chemical dispensing heads over each cup; (1) computer monitor; (1) color printer; and software (computer program) to operate the above-mentioned apparatus.

The preferred embodiment of high-throughput testing system 340 may operate as follows. An operator programs/selects a recipe from the computer program. The recipe may include information such as amount of pulp, volume of each chemical, dye or pigment slurry added, as well as levels of turbulence and durations of mixing. Pulp slurries are prepared by the operator at the proper consistencies and poured into each cup. The computer program optimizes the sequencing of the chemical addition, mixing and pad forming tasks. The sequencing avoids any interference between the different tasks and ensures that each tool is only requested by one task at any given time. For each cup experiment, up to ten chemicals/dyes/liquid pigment slurry can be added at programmable intervals. The gantry positions itself above the appropriate cup, dispenses the requested chemical volume, and then proceeds to its next task. Up to five mixing periods can be programmed, and duration and turbulence levels are fully programmable.

At the end of each cup experiment, the corresponding mixer is raised out of the slurry and the pad is formed. The operator can choose to form the pad under vacuum or atmospheric conditions. The filtrate is collected in a tank where conductivity and turbidity are measured. After all (24) experiments are completed, the gantry moves to its park position, cups and pads are removed for further testing (e.g., basis weight, formation, scattering coefficient, ash content). The operator can then ask for a cleaning of the instrument or a new test.

More specifically, the preferred embodiment of high-throughput testing system 340 will include the following features which are specific to paper manufacturing parameters, although the high-throughput testing system 340 of the present is not limited to paper manufacturing. The volume of the testing cup ensures that the volume is enough for high turbulence, and diameter of the testing cup is large enough for pH, temperature and flocculation measurements. Thus, the cup volume may be between 800 ml to 1 liter. While the cup diameter may be 3.5 inches (approximately 90 mm). The cup height may be between 128 mm (800 ml cup) and 160 mm (1 liter cup). However, exact cup dimensions may be subject to changes.

High-throughput testing system 340 will allow for easy loading of 300 ml to 400 ml of fiber's suspension to each of the (24) cups. The addition of chemicals preferably will fill out the volume up to 500 ml. The motor and chemical dispensing platform will be retracted for the initial step of loading the pulp samples to provide complete access to all cups from the top.

Mixing of fiber suspension in each cup will be independent for each cup to allow for independent programming of turbulence. The propeller (perforated disk type) and rotational speed (0-1500 rpm) will be similar to these used in the DAS300 Drainage Jar.

The following wet end chemistry process variables will be monitored as a function of time in each cup: consistency, temperature, and pH and flocculation level. The original consistency of poured fiber suspension plus the changes caused by the addition of chemicals will be monitored. It will be possible to monitor temperature in the in the range 10-80° C. with an accuracy of ±0.1° C., pH in full range with an accuracy of ±0.05 pH, and pulp flocculation with an accuracy of ±2%. Actual sampling frequency may be in the 10 to 250 kHz range. However, because of the huge number of data points collected, the relatively slow dynamics of the process and the response time of most sensors, the data will be written to file only at a 10 Hz frequency, i.e., 10 points per second or 1800 points for a three-minute test. The operator will be able to decrease that update frequency in order to reduce the size of the data files.

Simulation of wet end chemistry process in each cup will include the sequence and timing of dosing chemicals with the following pumps: three pigment slurry pumps of 5% consistency to deliver up to 25 ml per cup (medium-viscosity pumps); three chemical pumps to deliver volumes in the range of 1 to 5 ml (small-volume pumps); three chemical pumps to deliver volumes in the range of 5 to 50 ml (medium-volume pumps); and one pump to deliver higher volumes up to 100-200 ml for dilution water, chemical rinse and other utilities (high-volume pump). Such a pump selection might be useful for a typical experiment, but it is possible to amend the ranges and quantities of each type of pump.

Simulation of a fast paper machine will last 60 seconds×24 cups=24 minutes. This time includes only the actual “addition” sequence, i.e., a combination of chemical additions and agitations. In addition to the sequence itself, other tasks have to be taken into account to figure out the total duration of a complete test. These tasks include the following. Preparation of the high-throughput testing system 340 (e.g., warm up, sequence selection, a rinse sequence if the machine has not been used just before the test, etc.). Estimated time for preparation will be 20-40 minutes.

Another task is the preparation of the pulp suspension at the appropriate consistency, which may include the following tasks: disintegration of dry pulp samples, dilution to approximate consistency, consistency check with microwave oven or drying scale) and dilution fine-tuning. Estimated time for preparation of the pulp suspension will be 30-60 minutes. If the samples have to be soaked before disintegration, allow for the soaking to be done overnight on the day prior to the experiment.

Loading of the chemicals and slurries into respective tanks at proper consistency is another task to consider. Estimated time for loading of chemicals and slurries will be 30-60 minutes depending on number of chemicals and level of handling (especially for pigment slurries). Still another task to consider is the loading of the pulp samples in the cups. An accurate amount of pulp must be delivered into each cup. This could be done by volume with a graduated cylinder or by weight with a scale, and could last about 40-60 minutes.

After the test has been completed, pulp pads must be removed from the septi, labeled and stored for future testing. This step could also include pressing, drying or a combination of both. Estimated time for this part of the process is 30-40 minutes or more if pressing and drying must be done immediately. Some of these tasks can be done while the next test is running.

After all pads have been removed, the system must be cleaned thoroughly to remove any leftover pulps and chemical deposits. The estimated time for cleaning is about 30 minutes to at least 1 hour if slurry tanks need to be cleaned.

In addition, there are other factors that can affect the total duration of the test. For each cup the drainage time is a factor that can vary tremendously depending on the nature of the pulp and the chemical additives. Drainage time can be as little as a few seconds or as long as 20 seconds for certain combinations of pulps and additives. The vacuum pump cannot operate all the time, but rather will need at least 30 seconds to recover its full vacuum buffer after a drainage test. Since the filtrate parameters in a single measuring tank are measured, the filtrate will need to be drained between each test in the sequence. This will add 30 seconds to 1 minute to each test. Finally, traveling from cup to cup and dispensing chemicals are discrete actions that require a given amount of time to complete. Although this is not expected to be a large amount of time, it will add to the total time required to complete a single test.

Therefore, a full sequence of 24 one-minute tests will actually last 3 to 4 hours when all tasks are included that need to be performed to ensure a reliable test. Of course, it is always possible to save some time by skipping some of the tasks or performing some of the tasks while some another test is running. Actual timing and step duration will vary according to user and type of experiment.

Simulation of a slow paper machine will take 180 seconds×24 cups=72 minutes. For the three-minute experiments, the same actual timing for such tests will hold true, although the actual chemical additions and agitations might only last 72 minutes.

After dosing of chemicals is completed, turbulence will settle for a user-programmed time in the range 0.1 to 10 seconds. At the end of the each test, drainage of fiber mat will be done under vacuum with two options available: (1) under a given level of vacuum for a certain time (1-60 seconds), where both vacuum level and suction time are programmable by operator; or (2) under a given vacuum level and until the vacuum level reaches a stable plateau; a time-out will stop the experiment if it lasts more than a pre-set time; all parameters are user-programmable (vacuum level and time-out).

Filtrate collected in the lower cup will measured in the master cup for: (1) conductivity with a precision of ±1% full scale; and (2) turbidity (retention) with a precision of ±2% full scale. Filtrate from the master cup will be manually collected or released to the drain. The operator will have the option of being prompted by system to place a beaker under the drain spout in order to collect the filtrate. If this option is not selected, the filtrate will flow directly to the drain without warning to the operator.

Wet fiber mats will be collected and passed to other testing equipment. Pads should be labeled with a wet pencil, deposited onto the belt, automatically fed into the press and then in between the felt and the dryer for a complete revolution. Additional revolutions might be required depending on water retention and weight of the pads. If drying the pads is not desired, they may be preserved in plastic bags and stored in a refrigerator until they can be tested.

All timed events (agitation, settling, etc.) are programmable by the operator in increments of 0.1 second. Data recording is also done by default at the same resolution (0.1 second), i.e., at a frequency of 10 Hz.

Three of the ten chemicals may be pigment slurries. Instead of a standard container used for the chemical additives, the slurries will be kept in Plexiglas tanks. The tanks may be larger than the chemical bottles and easier to clean. The pump inlet may be higher than the bottom of the tank to prevent feeding agglomerated and settled particles to the experiment cups. In addition, the slurries may be kept from settling by the constant but gentle agitation of paint mixers. A bottom manual valve may allow draining of the leftover slurries at the end of each experiment.

All data acquisition from high-throughput testing system 340 and control of the instrument shall be done through data acquisition cards in a personal computer which connects to the individual sensors. The rate of acquisition for each sensor may be set between 10 and 50 kHz or more. The data is averaged to a frequency of 10 Hz, i.e., 10 data records per second. The user will be able to change the acquisition frequency between 1 and 100 Hz. Each data record consists of a series of readings (one per sensor). The format of the data records is comma-delimited text file. It is a simple text format that can easily be opened by Microsoft Excel or any other database program. The personal computer shall be able to capture records up to at least 50 kHz. In the data file, each line is a full record, i.e., a reading of all sensors at a point in time. Each column will contain the readings of a particular sensor during the course of the test, i.e., one column per sensor. This way it will be easy to plot sensor readings versus time.

B. Advantages of the Optyxx System

The system and method of the present invention provides the catalyst for future innovations in various industries. Many industries need new ideas and options to optimize their businesses, and with the current focus on consolidation and cost elimination, the present invention provides a very cost-efficient mechanism to stay in front of the competition.

The system and method of the present invention utilizes its technology and knowledge to find cost savings through the optimization of the machines and the chemical combinations. The system and method of the present invention create operational baselines for a manufactures and has advanced measurement and recording capabilities that allow for the determination of the correct combination of inputs. This knowledge provides an opportunity for the manufacturers to minimize the use of materials and maximize the throughput of their plant. In the end, the savings per manufacturer will be substantial due to prevention of waste and product loss.

The flipside of the cost and profit pressures facing industries today is the need to innovate with new products. Many manufacturers lack the internal resources to develop competitive new products. The companies that can create new offerings generally do so at a pace that takes between two and five years. This cycle is too capital intensive and time consuming for most companies. The system and method of the present invention allow for online new product collaboration between the manufacturer's machine, the customized databases, and high-throughput testing capability. By utilizing both the present invention and industry-specific scientific knowledge, there is a tremendous opportunity to create new products and help manufacturers stay ahead of their market needs.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A computer-implemented system for measuring and improving manufacturing processes and maximizing product research and development speed and efficiency, the system comprising:
a memory configured to store instructions;
a processor configured to execute instructions for:
a predictive model that predicts an output from data input,
an optimizer that optimizes input variables based upon desired output variables,
a library that stores data and information, and
an artificial intelligence that receives requests and information from one of manufacturers or customers, and directs the requests and information to the predictive model if an output prediction is requested by one of the manufacturers or customers, to the optimizer if an optimized input based on a desired output is requested by one of the manufacturers or customers, or to the library if the requests from one of the manufacturers or customers cannot be answered by the predictive model or the optimizer, wherein the predictive model, the optimizer, and the library interconnect with the artificial intelligence; and
a high-throughput screening system for analyzing various material combinations and sending data to the library.

2. A computer-implemented system as recited in claim 1, wherein the predictive model further performs a what if analysis.

3. A computer-implemented system as recited in claim 1, wherein the artificial intelligence receives requests and information from one of the manufacturers or customers via the Internet.

4. A computer-implemented system as recited in claim 1, wherein the high-throughput screening system sends data via the Internet.

5. A computer-implemented system as recited in claim 1, further comprising means for supplying information and data received from one of research laboratories or universities, via the Internet, to the library.

6. A computer-implemented system as recited in claim 1, further comprising means for supplying information and data received from the Internet regarding the latest developments in the field of one of the manufacturers or customers to the library.

7. A computer-implemented system for measuring and improving manufacturing processes and maximizing product research and development speed and efficiency, the system comprising:
a memory configured to store instructions;
a processor configured to execute instructions for:
a predictive model that predicts an output from input data supplied by one of manufacturers or customers,
an optimizer that optimizes input variables based upon desired output variables requested by one of the manufacturers or customers, and
a library that stores data and information from one of the manufacturers or customers; and
a high-throughput screening system for analyzing various material combinations and sending data to the library.

8. A computer-implemented system as recited in claim 7, wherein the predictive model further performs a what if analysis.

9. A computer-implemented system as recited in claim 7, wherein the requests and information from one of the manufacturers or customers is supplied via the Internet.

10. A computer-implemented system as recited in claim 7, wherein the high-throughput screening system sends data via the Internet.

11. A computer-implemented system as recited in claim 7, further comprising means for supplying information and data received from one of research laboratories or universities, via the Internet, to the library.

12. A computer-implemented system as recited in claim 7, further comprising means for supplying information and data received from the Internet regarding the latest developments in the field of one of the manufacturers or customers to the library.

13. A computer-implemented method for measuring and improving manufacturing processes and maximizing product research and development speed and efficiency, comprising:
providing a predictive model that predicts an output from data input;
providing an optimizer that optimizes input variables based upon desired output variables;
providing a library that stores data and information;
providing an artificial intelligence that receives requests and information from one of manufacturers or customers, and directs the requests and information to the predictive model if an output prediction is requested by one of the manufacturers or customers, to the optimizer if an optimized input based on a desired output is requested by one of the manufacturers or customers, or to the library if the requests from one of the manufacturers or customers cannot be answered by the predictive model or the optimizer, wherein the predictive model, the optimizer, and the library interconnect with the artificial intelligence; and
providing a high-throughput screening system for analyzing various material combinations and sending data to the library.

14. A computer-implemented method as recited in claim 13, wherein the predictive model further performs a what if analysis.

15. A computer-implemented method as recited in claim 13, wherein the artificial intelligence receives requests and information from one of the manufacturers or customers via the Internet.

16. A computer-implemented method as recited in claim 13, wherein the high-throughput screening system sends data via the Internet.

17. A computer-implemented method as recited in claim 13, further comprising supplying information and data received from one of research laboratories or universities, via the Internet, to the library.

18. A computer-implemented method as recited in claim 13, further comprising supplying information and data received from the Internet regarding the latest developments in the field of one of the manufacturers or customers to the library.

19. A computer-implemented method for measuring and improving manufacturing processes and maximizing product research and development speed and efficiency, comprising:
providing a predictive model that predicts an output from input data supplied by one of manufacturers or customers;
providing an optimizer that optimizes input variables based upon desired output variables requested by one of the manufacturers or customers;
providing a library that stores data and information from one of the manufacturers or customers; and
providing a high-throughput screening system for analyzing various material combinations and sending data to the library.

20. A computer-implemented method as recited in claim 19, wherein the predictive model further performs a what if analysis.

21. A computer-implemented method as recited in claim 19, wherein the requests and information from one of the manufacturers or customers is supplied via the Internet.

22. A computer-implemented method as recited in claim 19, wherein the high-throughput screening system sends data via the Internet.

23. A computer-implemented method as recited in claim 19, further comprising supplying information and data received from one of research laboratories or universities, via the Internet, to the library.

24. A computer-implemented method as recited in claim 19, further comprising supplying information and data received from the Internet regarding the latest developments in the field of one of the manufacturers or customers to the library.

25. A method for measuring and improving manufacturing processes and maximizing product research and development speed and efficiency, comprising:
predicting an output from data input with a predictive model;
optimizing input variables based upon desired output variables with an optimizer;
storing data and information in a library;
receiving requests and information from one of manufacturers or customers with an artificial intelligence, and directing the requests and information to the predictive model if an output prediction is requested by one of the manufacturers or customers, to the optimizer if an optimized input based on a desired output is requested by one of the manufacturers or customers, or to the library if the requests from one of the manufacturers or customers cannot be answered by the predictive model or the optimizer; and
analyzing various material combinations and sending data to the library with a high-throughput screening system.

26. A method as recited in claim 25, wherein the predictive model further performs a what if analysis.

27. A method as recited in claim 25, wherein the artificial intelligence receives requests and information from one of the manufacturers or customers via the Internet.

28. A method as recited in claim 25, wherein the high-throughput screening system sends data via the Internet.

29. A method as recited in claim 25, further comprising supplying information and data received from one of research laboratories or universities, via the Internet, to the library.

30. A method as recited in claim 25, further comprising supplying information and data received from the Internet regarding the latest developments in the field of one of the manufacturers or customers to the library.

31. A method for measuring and improving manufacturing processes and maximizing product research and development speed and efficiency, comprising:
predicting an output from input data supplied by one of manufacturers or customers with a predictive model;
optimizing input variables based upon desired output variables requested by one of the manufacturers or customers with an optimizer;
storing data and information from one of the manufacturers or customers in a library; and
analyzing various material combinations and sending data to the library with a high-throughput screening system.

32. A method as recited in claim 31, wherein the predictive model further performs a what if analysis.

33. A method as recited in claim 31, wherein the requests and information from one of the manufacturers or customers is supplied via the Internet.

34. A method as recited in claim 31, wherein the high-throughput screening system sends data via the Internet.

35. A method as recited in claim 31, further comprising supplying information and data received from one of research laboratories or universities, via the Internet, to the library.

36. A method as recited in claim 31, further comprising supplying information and data received from the Internet regarding the latest developments in the field of one of the manufacturers or customers to the library.

37. A computer readable medium that stores instructions executable by at least one processor to perform a method for measuring and improving manufacturing processes and maximizing product research and development speed and efficiency, comprising instructions for:
predicting an output from data input with a predictive model;
optimizing input variables based upon desired output variables with an optimizer;
storing data and information in a library; and
receiving requests and information from one of manufacturers or customers with an artificial intelligence, and directing the requests and information to the predictive model if an output prediction is requested by one of the manufacturers or customers, to the optimizer if an optimized input based on a desired output is requested by one of the manufacturers or customers, or to the library if the requests from one of the manufacturers or customers cannot be answered by the predictive model or the optimizer, wherein various material combinations are analyzed and data is sent to the library with a high-throughput screening system.

38. A computer readable medium as recited in claim 37, wherein the predictive model further performs a what if analysis.

39. A computer readable medium as recited in claim 37, wherein the artificial intelligence receives requests and information from one of the manufacturers or customers via the Internet.

40. A computer readable medium as recited in claim 37, wherein the high-throughput screening system sends data via the Internet.

41. A computer readable medium as recited in claim 37, wherein information and data received from one of research laboratories or universities is supplied, via the Internet, to the library.

42. A computer readable medium as recited in claim 37, wherein information and data received from the Internet regarding the latest developments in the field of one of the manufacturers or customers is supplied to the library.

43. A computer readable medium that stores instructions executable by at least one processor to perform a method for measuring and improving manufacturing processes and maximizing product research and development speed and efficiency, comprising instructions for:
predicting an output from input data supplied by one of manufacturers or customers with a predictive model;
optimizing input variables based upon desired output variables requested by one of the manufacturers or customers with an optimizer; and
storing data and information from one of the manufacturers or customers in a library; wherein various material combinations are analyzed and data is sent to the library with a high-throughput screening system.

44. A computer readable medium as recited in claim 43, wherein the predictive model further performs a what if analysis.

45. A computer readable medium as recited in claim 43, wherein the requests and information from one of the manufacturers or customers is supplied via the Internet.

46. A computer readable medium as recited in claim 43, wherein the high-throughput screening system sends data via the Internet.

47. A computer readable medium as recited in claim 43, wherein information and data received from one of research laboratories or universities is supplied, via the Internet, to the library.

48. A computer readable medium as recited in claim 43, wherein information and data received from the Internet regarding the latest developments in the field of one of the manufacturers or customers is supplied to the library.

49. A computer-implemented system for measuring and improving manufacturing processes and maximizing product research and development speed and efficiency, the system comprising:
a memory configured to store instructions; and
a processor configured to execute instructions for:
a predictive model that predicts an output from data input,
an optimizer that optimizes input variables based upon desired output variables,
a library that stores data and information, and
an artificial intelligence that receives requests and information from one of manufacturers or customers, and directs the requests and information to the predictive model if an output prediction is requested by one of the manufacturers or customers, to the optimizer if an optimized input based on a desired output is requested by one of the manufacturers or customers, or to the library if the requests from one of the manufacturers or customers cannot be answered by the predictive model or the optimizer, wherein the predictive model, the optimizer, and the library interconnect with the artificial intelligence.

50. A computer-implemented system for measuring and improving manufacturing processes and maximizing product research and development speed and efficiency, the system comprising:
a memory configured to store instructions; and
a processor configured to execute instructions for:
a predictive model that predicts an output from input data supplied by one of manufacturers or customers,
an optimizer that optimizes input variables based upon desired output variables requested by one of the manufacturers or customers, and
a library that stores data and information from one of the manufacturers or customers.

51. A computer-implemented method for measuring and improving manufacturing processes and maximizing product research and development speed and efficiency, comprising:
providing a predictive model that predicts an output from data input;
providing an optimizer that optimizes input variables based upon desired output variables;
providing a library that stores data and information; and
providing an artificial intelligence that receives requests and information from one of manufacturers or customers, and directs the requests and information to the predictive model if an output prediction is requested by one of the manufacturers or customers, to the optimizer if an optimized input based on a desired output is requested by one of the manufacturers or customers, or to the library if the requests from one of the manufacturers or customers cannot be answered by the predictive model or the optimizer, wherein the predictive model, the optimizer, and the library interconnect with the artificial intelligence.

52. A computer-implemented method for measuring and improving manufacturing processes and maximizing product research and development speed and efficiency, comprising:
providing a predictive model that predicts an output from input data supplied by one of manufacturers or customers;
providing an optimizer that optimizes input variables based upon desired output variables requested by one of the manufacturers or customers; and
providing a library that stores data and information from one of the manufacturers or customers.

53. A method for measuring and improving manufacturing processes and maximizing product research and development speed and efficiency, comprising:
predicting an output from data input with a predictive model;
optimizing input variables based upon desired output variables with an optimizer;
storing data and information in a library; and
receiving requests and information from one of manufacturers or customers with an artificial intelligence, and directing the requests and information to the predictive model if an output prediction is requested by one of the manufacturers or customers, to the optimizer if an optimized input based on a desired output is requested by one of the manufacturers or customers, or to the library if the requests from one of the manufacturers or customers cannot be answered by the predictive model or the optimizer.

54. A method for measuring and improving manufacturing processes and maximizing product research and development speed and efficiency, comprising:
predicting an output from input data supplied by one of manufacturers or customers with a predictive model;
optimizing input variables based upon desired output variables requested by one of the manufacturers or customers with an optimizer; and
storing data and information from one of the manufacturers or customers in a library.

55. A computer readable medium that stores instructions executable by at least one processor to perform a method for measuring and improving manufacturing processes and maximizing product research and development speed and efficiency, comprising instructions for: predicting an output from data input with a predictive model;
optimizing input variables based upon desired output variables with an optimizer;
storing data and information in a library; and
receiving requests and information from one of manufacturers or customers with an artificial intelligence, and directing the requests and information to the predictive model if an output prediction is requested by one of the manufacturers or customers, to the optimizer if an optimized input based on a desired output is requested by one of the manufacturers or customers, or to the library if the requests from one of the manufacturers or customers cannot be answered by the predictive model or the optimizer.

56. A computer readable medium that stores instructions executable by at least one processor to perform a method for measuring and improving manufacturing processes and maximizing product research and development speed and efficiency, comprising instructions for:
predicting an output from input data supplied by one of manufacturers or customers with a predictive model;
optimizing input variables based upon desired output variables requested by one of the manufacturers or customers with an optimizer; and
storing data and information from one of the manufacturers or customers in a library.
